(19) United States
(12) Patent Application Publication
(10) Pub. No.: US 2006/0225310 A1
(43) Pub. Date: Oct. 12, 2006

(54) Work machine alignment system and method of maintaining alignment of a work machine

(76) Inventor: Roger D. Koch, Pekin, IL (US)

Correspondence Address: Michael B. McNeil;Liell & McNeil Attorneys PC, P.O. Box 2417, Bloomington, IN, 47402, US

(21) Appl. No.: 11/103,767

(22) Filed: Apr. 12, 2005

(51) Int. Cl. E02F 5/22; G05D 1/02; G05D 1/04; E02F 5/02

(52) U.S. Cl. 37/348

(57) ABSTRACT

Maintaining alignment of a work machine with a predetermined work machine path over a relatively lengthy distance can be difficult. In order to maintain alignment of a work machine with a predetermined work machine path, the present disclosure includes a work machine alignment system that includes a laser generator operable to produce a laser vertical plane parallel to a determined work machine path, and a laser receiver group operable to sense a position of the laser vertical plane within a horizontal laser sensing width of the laser receiver group. One of the laser receiver group or the laser generator is attached to a work machine body of the work machine at a fixed location. The laser receiver group is in communication with an electronic control module that includes a work machine alignment assistance algorithm.

### TECHNICAL FIELD

The present disclosure relates generally to control of work machines, and more specifically to a method and system for maintaining alignment of a work machine with a predetermined work machine path.

### BACKGROUND

In certain situations, a work machine operator must maintain alignment of the work machine with a straight path over a relatively long distance. For instance, an operator must maintain alignment of a trenching work machine, such as a backhoe loader, with a predetermined path of a trench over a relatively long distance. Generally, a surveyor will determine and mark with paint or a stake a start point and an end point of the trench. The operator can then align the backhoe loader with the paint mark or surveyor stake at the start point. Assuming that the backhoe loader is not operating in a limited space, the operator will align a work machine axis, being a center line of the work machine body, with the predetermined path of the trench. The operator will then align an implement plane, being the vertical plane in which the backhoe will move while digging, with the work machine axis. The operator can align the implement plane with the work machine axis by sight and/or with the use of sensors that can sense the position of the backhoe with respect to the backhoe loader body.

Although the operator can generally accurately align the backhoe loader with the start point of the predetermined path of the trench, it is more difficult to maintain alignment of the backhoe loader with the predetermined path as the backhoe progresses along the predetermined trench path. The operator will dig a portion of the trench, and then reposition the machine to dig another portion of the trench. The process will repeat itself until the relatively lengthy trench is dug. In order to move the backhoe loader between digging positions along the trench path, skilled operators will generally use a method known in the art as the “duck walk.” The “duck walk” method moves the backhoe loader by pushing with the backhoe linkage. The front of the backhoe loader is moved forward on the bottom surface of the loader bucket. Although the “duck walk” has been found to be a more efficient method of repositioning the backhoe loader than driving the backhoe loader, the operator will generally remain facing rearward towards the backhoe while performing the “duck walk.” Thus, the operator might lack a clear view of the trench end point and often strays off course.

Even if the operator only veers off course slightly with each repositioning, the errors can accumulate, causing significant deviation from the predetermined trench path. Repositioning from a significant deviation with the path takes time away from digging the trench. Moreover, the operator may overcorrect the deviation from the predetermined path and cause the trench to zig zag along a centerline of the predetermined trench path. Even if the work machine axis of the backhoe loader remained aligned with the predetermined path of the trench, the trench will veer away from the predetermined path if the operator misaligns the implement plane of the backhoe with predetermined path. Thus, in order to dig a trench in a straight line for a relatively long distance, the operator of the work machine must be able to repeatedly reposition the backhoe loader and maintain alignment of the work machine with the predetermined path of the trench while facing rearward. This can prove difficult for even the most skilled operators.

In order to increase the accuracy of digging a relatively long trench, there are various methods of positioning and determining a heading of the work machine, such as the method disclosed in U.S. Pat. No. 6,418,3645 B1, issued to Kalafut et al., on Jul. 9, 2002. Although these positioning methods may increase the accuracy of trench digging along a straight line, the methods, and systems, are often complicated and include expensive global positioning systems.

The present disclosure is aimed at overcoming one or more of the problems set forth above.

### SUMMARY OF THE INVENTION

In one aspect of the present disclosure, a work machine includes a laser receiver group with at least one laser receiver positioned at a fixed location on a work machine body. The laser receiver group is operable to sense a laser vertical plane and includes more than one laser sensing point along a horizontal laser sensing width. The laser receiver group is in communication with an electronic control module that includes a work machine alignment assistance algorithm.

In another aspect of the present disclosure, a work machine alignment system includes a work machine with a work machine body to which at least one of a laser generator and a laser receiver group is attached. The laser generator is operable to produce a laser vertical plane parallel to a predetermined work machine path, and a laser receiver group is operable to sense a position of the laser vertical plane within a horizontal laser sensing width of the laser receiver group. An electronic control module is in communication with the laser receiver group and includes a work machine alignment assistance algorithm.

In yet another aspect of the present disclosure, alignment of a work machine along a predetermined work machine path is maintained by aligning at least one of an implement plane and a work machine axis of the work machine with the predetermined work machine path. A laser generator casts a laser vertical plane parallel to the predetermined work machine path. A position of the laser vertical plane within a horizontal laser sensing width of a laser receiver group is sensed. The laser receiver group is attached at a fixed position to a work machine body of the work machine. The position of the laser vertical plane within the horizontal laser sensing width is maintained at each of a plurality of work machine positions along the predetermined work machine path.

### BRIEF DESCRIPTION OF THE DRAWINGS

FIG. 1a is a diagrammatic representation of a top view of a work machine alignment system with a work machine in a preferred aligned position, according to the present disclosure;

FIG. 1b is a diagrammatic representation of a top view of the work machine alignment system with the work machine of FIG. 1a in an alternative aligned position;

FIG. 2 is a diagrammatic representation of an alignment deviation indicator within the work machine alignment system of FIG. 1a; and

FIG. 3 is a flow chart of a work machine alignment assistance algorithm within the work machine alignment system of FIG. 1a.

### DETAILED DESCRIPTION

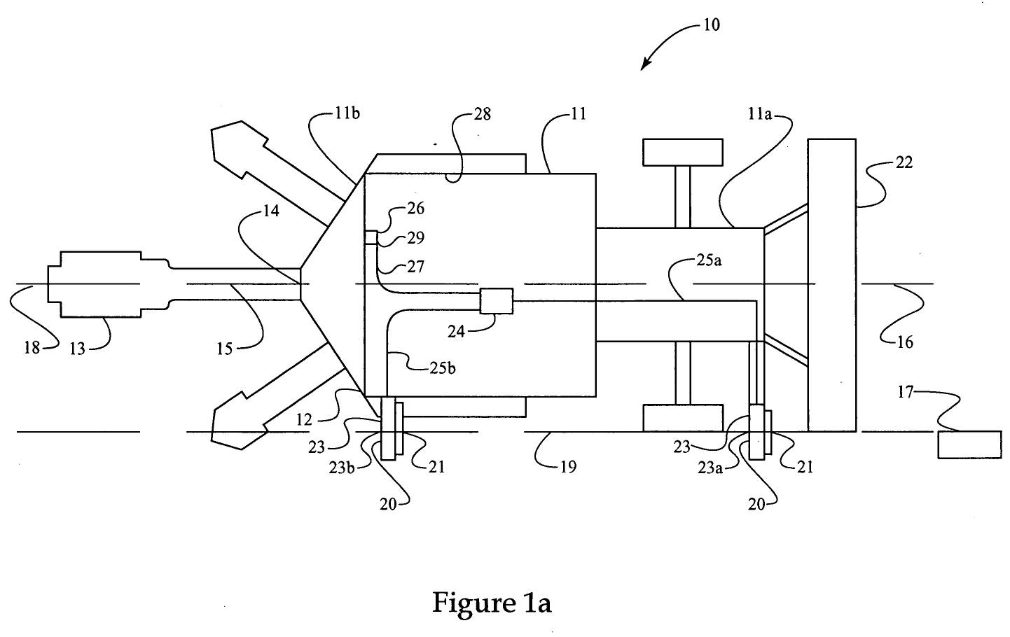

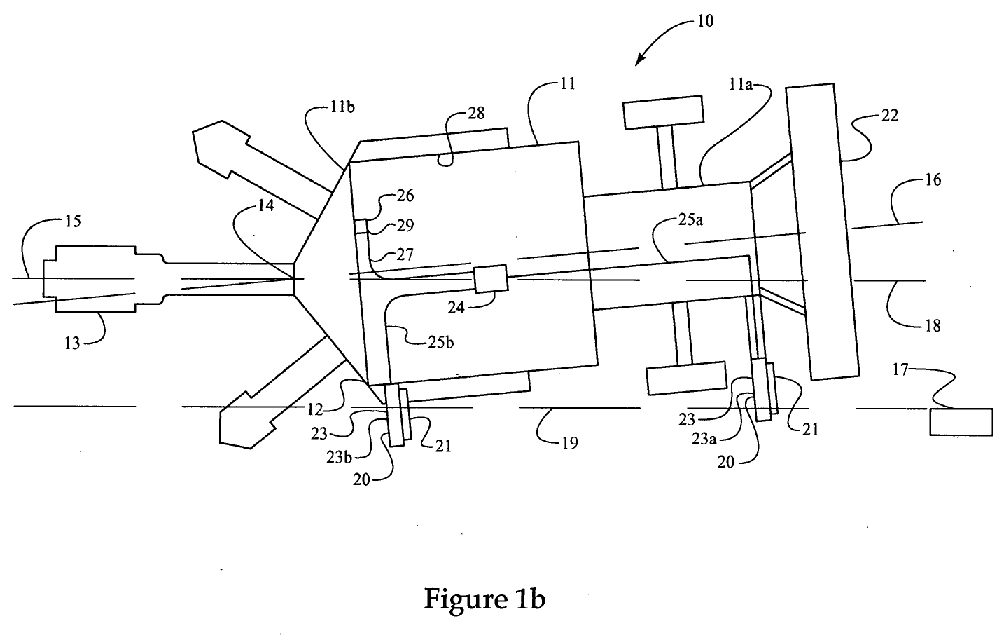

Referring to FIG. 1a, there is shown a top view of a work machine alignment system 10 with a work machine 11 in a preferred aligned position, according to the present disclosure. The work machine 11 includes a work machine body 12 to which a digging implement 13 that may be moveably attached about a pivot 14. Although the digging implement 13 is preferably a backhoe and the work machine 11 is preferably a backhoe loader, it should be appreciated that the work machine alignment system 10 could be used with other digging work machines, including, but not limited to, dozers and excavators, and may be non-pivoting trenchers. It should be appreciated that the work machine alignment system 10 could also be used with work machines without digging implements. For instance, the present disclosure contemplates being used to maintain alignment of a crop harvesting work machine with a predetermined harvesting path as the machine proceeds through a crop field.

The backhoe loader 11 is intended to operate along a predetermined work machine path 18. The predetermined work machine path 18 is the desired path of the work machine. In the illustrated embodiment, the predetermined work machine path 18 is a centerline of a trench that is to be dug by the backhoe loader 11. Those skilled in the art will appreciate that the predetermined work machine path 18, being the location of the trench, will generally be determined prior to digging by any conventional surveying means. Once the location of the predetermined work machine path 18, or trench, at a job site has been determined, a surveyor will likely mark a starting point and an ending point of the predetermined work machine path 18 by various means, such as with stakes or paint.

The work machine body 12 of the backhoe loader 11 includes a front portion 11a to which a loader 22 is moveable attached and a back portion 11b to which the backhoe 13 is movably attached via the pivot 14. The backhoe loader 11 includes the work machine axis 16 and an implement plane 15. The work machine axis 16 is a centerline through the body 12 of the backhoe loader 11. The implement plane 15 is the vertical plane in which the backhoe 13 can move about the pivot 14 with respect to the work machine body 12 to dig a trench. Those skilled in the art will appreciate that the backhoe 13 can also be moved in a horizontal plane with respect to the work machine body 12. Thus, the implement plane 15 need not be aligned with the work machine axis 16 during digging. However, in the preferred aligned position, the implement plane 15 is aligned with the work machine axis 16, and the work machine axis 16 is aligned with the predetermined work machine path 18.

Referring to FIG. 1b, there is shown the work machine alignment system 10 with the backhoe loader 11 in an alternative aligned position. When the backhoe loader 11 is in the alternative aligned position, the work machine axis 16 of the backhoe loader 11 is out of alignment with the predetermined work machine path 18 and the implement plane 15. Although the implement plane 15 is aligned with the predetermined work machine path 18, the work machine axis 16 might be angled from the predetermined work machine path 18. Thus, the backhoe 13 can still dig along the predetermined work machine path 18, although the work machine body 12 is positioned at an angle to the work machine path 18. Those skilled in the art will appreciate that space constraints may require that the operator angle the work machine body 12 from the predetermined work machine path 18.

Referring to both FIGS. 1a and 1b, the work machine alignment system 10 includes a laser generator 17 operable to cast a laser vertical plane 19 parallel to the predetermined work machine path 18. The alignment system 10 also includes a laser receiver group 20 including at least one laser receiver 23 operable to sense a position of the laser vertical plane 19 within a horizontal laser sensing width 21 of the laser receiver group 20. It should be appreciated that laser generators that produce vertical laser planes are commercially available. Laser receivers that include horizontal laser sensing widths are also commercially available. Conventional laser receivers that are generally oriented vertically in order to include a vertical sensing height are instead oriented horizontally to provide the horizontal sensing width 21. Although the present disclosure contemplates either the laser receiver group 20 or the laser generator 17 being attached to the work machine body 12, the laser receiver group 20 (as shown) is preferably attached to the work machine body 12 at a fixed location. Those skilled in the art will appreciate that the laser generator 17 should be positioned such that laser vertical plane 19 is sufficiently close to the work machine body 12 in order to be sensed within the horizontal laser sensing width 21 of the at least one laser receiver 23. Thus, the laser generator 17 might be positioned on the ground a little more than half a width of the work machine body 12 from the predetermined work machine path 18.

Although the laser receiver group 20 could include any number of laser receivers, the laser receiver group 20 preferably includes two laser receivers, being a fore laser receiver 23a and an aft laser receiver 23b. In the illustrated embodiment, the laser receivers 23a and 23b are approximately one foot wide although the width can vary. Also, in the illustrated embodiment, the fore laser receiver 23a is attached to the work machine body 12 as far forward on the backhoe loader 11 as possible without interfering with the operation of the loader 22. The aft receiver 23b is preferably positioned adjacent to the pivot 14 without interfering with the movement of the backhoe 13. Although at least two laser receivers 23a and 23b are preferred, the present disclosure contemplates use with only one laser receiver, which might be the aft laser receiver 23b. The aft laser 23b can sense the distance between the laser vertical plane 19 and the back portion 11b of the backhoe loader 11 to which the pivot 14 is attached, thereby aiding in alignment of the implement plane 15 with the predetermined work machine path 18. If using only one receiver, it might be desirable to locate the receiver at about the same longitudinal position of pivot 14 along the work machine axis 16. Although not necessary, the backhoe loader 11 preferably includes conventional sensors that can sense the rotational position of the boom of the backhoe 13 to the work machine body 12 about pivot 14. The operation of these sensors is known in the art. It should be appreciated that the aft laser receiver 23b, alone, generally cannot sense the orientation of the work machine axis 16 to the vertical laser plane 19. The more laser receivers, the more accurate the sensed orientation of the backhoe loader 11 to the predetermined work machine path 18, but the more expensive the work machine alignment system 10. Those skilled in the art will appreciate that a tilt, or roll angle, of the work machine body 12 could be determined by use of an inclinometer or possibly by a third laser receiver.

The horizontal laser sensing width 21 is the horizontal distance in which the laser receiver group 20 can sense the laser vertical plane 19. The horizontal laser sensing width 21 includes more than one laser sensing point. Thus, if the backhoe loader 11 with the laser receivers 23a and 23b is moved out of alignment from the work machine path 18, the laser vertical plane 19 which remains stationary will be sensed at a different laser sensing point than it was when the backhoe loader 11 was aligned with the work machine path 18. Preferably, the horizontal laser sensing width 21, as illustrated, includes a continuous laser sensing width. In other words, each laser receiver 23a and 23b includes all of the laser sensing points within the sensing width 21. It should be appreciated that the present disclosure also contemplates the horizontal laser sensing width being divided among discrete multiple laser receivers distributed along a horizontal sensing width. For instance, each laser receiver could include only one laser sensing point along the horizontal laser sensing width. Each laser sensing point would be located at a different horizontal distance from the work machine body 12. Although the width of the horizontal laser sensing width 21 can vary, generally a width is between one foot and one and one half feet is adequate, but generally be at least four inches wide to accurately sense the alignment of the backhoe loader 11 and avoid having the laser plane move completely out of the sensing width when repositioning the work machine.

The backhoe loader 11 might include an electronic control module 24 that is in communication with the fore laser receiver 23a and the aft laser receiver 23b via a fore laser receiver communication line 25a and an aft laser receiver communication line 25b, respectively. The electronic control module 24 is also in communication with an alignment deviation indicator 26 via an indicator communication line 27. Although unlikely, the electronic control module need not necessarily be carried by the work machine, such as by wireless communication with an off-board electronic control module. The alignment deviation indicator 26 preferably includes a visual display 29, that is visible to an operator, such as located within an operator's compartment 28 of the backhoe loader 11. The alignment deviation indicator 26 is operable to provide alignment correction information to the operator. The visual display 29 might be positioned at any position within the operator's compartment that the operator, aligning the backhoe 13 and the backhoe loader 11, can easily view.

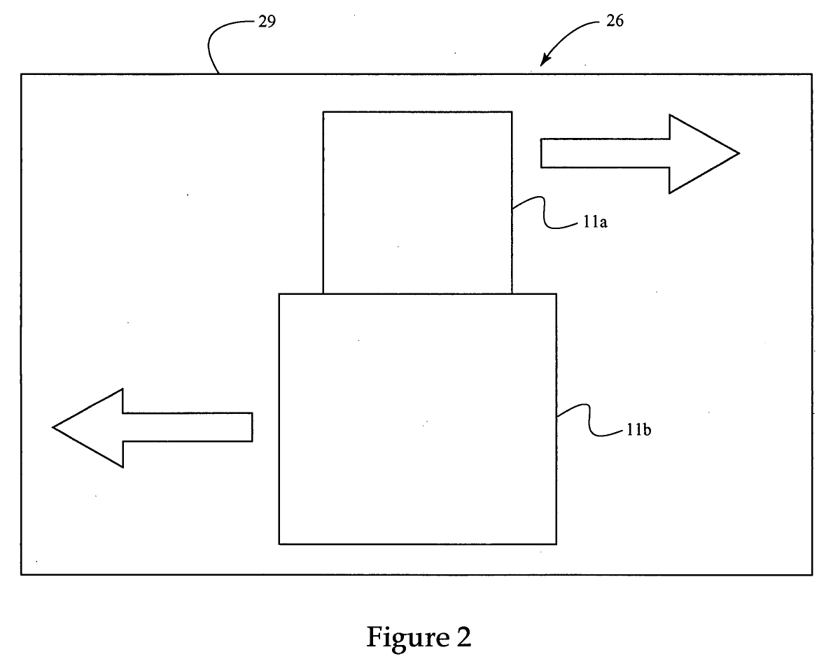

Referring to FIG. 2, there is shown a diagrammatic representation of the visual display 29 of the alignment deviation indicator 26 within the backhoe loader 11, according to the present disclosure. Although the visual display 29 can vary, in the illustrated embodiment, the visual display 29 displays alignment correction information by displaying a symbol representing the front portion 11a of the backhoe loader 11 and a symbol representing the back portion 11b of the backhoe loader 11. Arrows show which direction the front portion 11a and the back portion 11b of the backhoe loader 11 should be moved in order to align the backhoe loader 11 with the work machine path 18. The visual display 29 will not include arrows if the front portion 11a and the back portion 11b of the backhoe loader 11 are aligned with the predetermined work machine path 18. Those skilled in the art should appreciate that the present disclosure contemplates the alignment deviation indicator 26 including an audible cue in conjunction with the visual display or without the visual display. Moreover, the present disclosure contemplates the use of the laser receiver groups 20 and the laser vertical plane 19 with an automated alignment correction system wherein the electronic control module commands maneuvers to realign at each new work machine position.

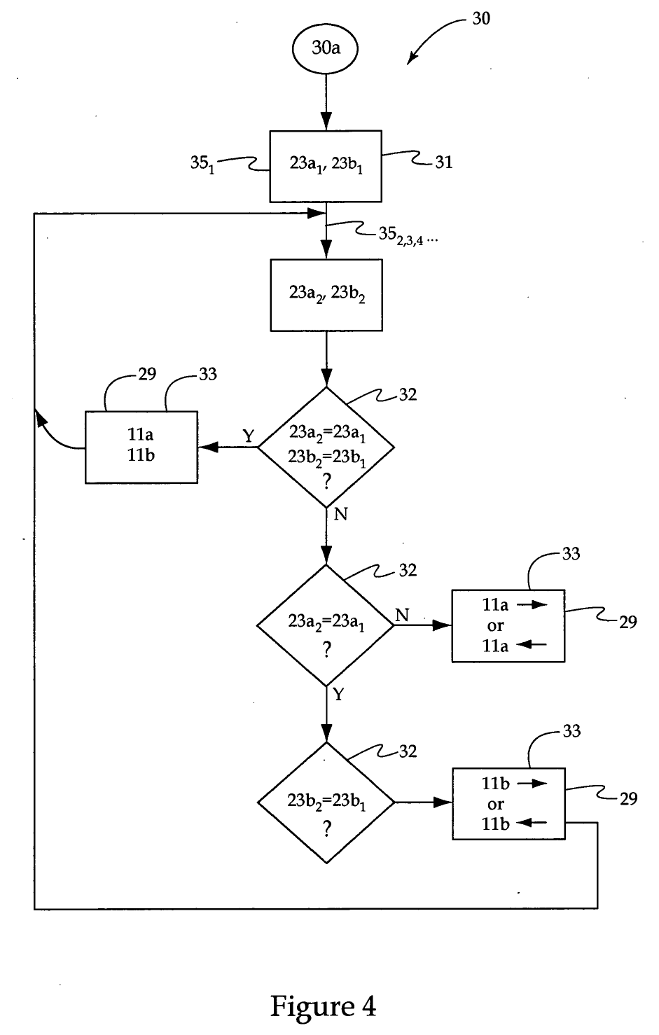

Referring to FIG. 3, there is shown a flow chart illustrating a work machine alignment assistance algorithm 30 within the electronic control module 24 of the work machine alignment system 10 of FIG. 1a. The work machine assistance algorithm 30 can be activated or started 30a by various means, including, but not limited to, sensors determining when the bucket of the backhoe loader 13 is in a digging position for the first time during operation or the operator manipulating a control. The work machine assistance algorithm 30 includes an initializing algorithm 31 being operable to determine an initial position 23a₁, 23b₁ of the laser vertical plane 19 within the horizontal laser sensing width 21 when the work machine 11 is aligned with the predetermined work machine path 18. The backhoe loader 11 is preferably aligned with the predetermined work machine path 18 when the implement plane 15 and the work machine axis 16 are aligned with the predetermined work machine path 18, as illustrated in FIG. 1a. The backhoe loader 11 aligned with the predetermined work machine path 18 before digging is in an initial work machine position 35₁. Laser receiver 23a and 23b will sense the initial position 23a₁ and 23b₁ of the vertical laser plane 19 within the horizontal sensing width 21, respectively. Preferably, the initial positions 23a₁ and 23b₁ are stored in the electronic control module 24.

As digging commences and progress, the operator will move the backhoe loader 11 among a plurality of work machine positions 35 along the predetermined work machine path 18. In the illustrated embodiment, each time the bucket of the backhoe 13 is determined to be in the digging position, the laser receivers 23a and 23b sense the position of the laser vertical plane 19 within the horizontal sensing width 21. Thus, when the backhoe loader 11 is moved to a subsequent position 35₂, the laser receivers 23a and 23b can sense a subsequent position 23a₂ and 23b₂ of the laser vertical plane 19 within the horizontal laser sensing width 21 before digging. A comparing algorithm 32 of the work machine assistance algorithm 30 is operable to compare the initial positions 23a₁, 23b₁ of the laser vertical plane 19 with the subsequent positions 23a₂, 23b₂ of the laser vertical plane 19 within the horizontal laser sensing width 21 when the backhoe loader 11 is at a corresponding subsequent work machine position 35₂. This information might also be supplied to the operator during while he or she is repositioning the work machine to possibly further improve efficiency.

An indicating algorithm 33 of the work machine alignment assistance algorithm 30 is operable to provide the alignment correction information to the operator. If both the subsequent positions 23a₂ and 23b₂ are within a predetermined tolerance of the initial positions 23a₁ and 23b₁ of the vertical laser plane 19 within the horizontal laser sensing width 21, then the indicating algorithm 33 will indicate that the front and back ends 11a and 11b of the backhoe loader 11 are aligned with the predetermined work machine path 18. Although there are various ways of indicating alignment, in the illustrated embodiment, the visual display 29 will indicate alignment by the absence of arrows near the symbols representing the back portion 11b and the front portion 11a of the backhoe loader 11.

If the comparing algorithm 32 determines that at least one of the subsequent positions 23a₂ and 23b₂ has changed from the initial positions 23a₁ and 23b₁ of the laser vertical plane 19 within the laser sensing width 21 greater than the predetermined tolerance, the comparing algorithm 32 will determine which laser vertical plane position 23a₂ or 23b₂ or both is different than the initial laser plane position 23a₁ or 23b₁. If the position of the laser vertical plane 19 within the laser sensing width 21 of the aft laser receiver 23b has changed, the indicating algorithm 33 will indicate that the back of the backhoe loader 11 is not aligned with the predetermined work machine path 18 and will indicate what direction the operator must move the back end 11b in order to align the back end 11b with the predetermined work machine path 18. If the position of the laser vertical plane 19 within the laser sensing width 21 of the fore laser receiver 23a has changed, the indicating algorithm 33 will indicate that the front portion 11a of the backhoe 11 is not aligned with the predetermined work machine path 18 and the direction the front portion 11a must be moved for alignment.

The present disclosure contemplates the work machine alignment assistance algorithm 30 being operable to maintain the alternative alignment of the backhoe loader 11, in which only the implement plane 15 remains aligned with the predetermined work machine path (shown in FIG. 1b). Those skilled in the art will appreciate that the work machine assistance algorithm 30 will operate similarly except that only the initial position 23b₁ of the vertical laser plane 19 within the horizontal laser sensing width 21 will be maintained.

Those skilled in the art will appreciate that the geometric equations and calculations to determine position of the pivot 14 and the orientation of the machine axis 16 with respect to the laser vertical plane 19 within the laser sensing width 21 are known in the art. Moreover, those skilled in the art will appreciate that rather than indicating to the operator the alignment correction information 29, the present disclosure contemplates the work machine assistance algorithm including an automated alignment correction algorithm that would be operable to command the work machine 11 to automatically correct the misalignment through appropriate work machine maneuvering.

### INDUSTRIAL APPLICABILITY

Referring to FIGS. 1a-3, a method of maintaining alignment of the backhoe loader 11 along the predetermined work machine path 18, being the centerline of the trench, will be discussed. Although the present disclosure will be discussed for the backhoe loader 11, it should be appreciated that the present disclosure contemplates use with various work machines. For instance, the work machine alignment system 10 of the present disclosure could find use with any work machine that must maintain alignment along a straight line, such as any work machine used to dig trenches or ditches or used to harvest crops within a large field. Moreover, although the method of maintaining the preferred alignment of the backhoe loader 11 will be discussed, the present disclosure operates similarly to maintain the alternative alignment shown in FIG. 1b. The only difference being that the initial position 23a₁ of the laser vertical plane 19 within the fore laser receiver 23a need not be maintained in order to maintain the alternative alignment of FIG. 1b. Those skilled in the art will appreciate that there are situations, such as when digging space is limited, that the alternative alignment is necessary.

Before digging the trench, the predetermined path of the work machine 18 is determined and marked by any one of the various conventional means. In the illustrated embodiment, surveyors will determine the trench path and mark the start and end of the trench path to be dug. The laser generator 17 will be positioned on or above the ground such that the laser vertical plane will be cast parallel to the work machine path 18. The laser generator 17 might also be distanced such that the laser vertical plane 19 is cast slightly over half of the width of the backhoe loader 11 from the predetermined work machine path 18. Thus, the laser receivers 23a and 23b will be positioned within the laser vertical plane 19 as the backhoe loader 11 proceeds through the plurality of work machine positions 35 along the predetermined path 18.

Before digging, the operator aligns at least one of the implement plane 15 and the work machine axis 16 of the backhoe loader 11 with the predetermined work machine path 18. In the preferred embodiment, as shown in FIG. 1a, the operator will align both the work machine axis 16 and the implement plane 15 with the predetermined work machine path 18. Because the start point and the end point of the predetermined work machine path 18 will generally be marked by a marker, such as a survey stake or paint mark, an operator of ordinary skill can properly align both the work machine axis 16 and the implement plane 15. Preferably, the operator will align the work machine axis 16 with the predetermined work machine path 18 and align the implement plane 15 with the aligned work machine axis 16. In many conventional backhoe loaders, sensors can sense the rotational position of the boom of the backhoe 13 to the work machine body 12 about pivot 19, and thus, can indicate whether the implement plane 15 is aligned with the machine axis 16, or at least, aid in alignment.

After the backhoe loader 11 is aligned with the predetermined work machine path 18, the work machine alignment assistance algorithm 30 can be activated 30a by the operator or by sensors determining that the backhoe 13 is in the digging position, i.e., the bucket teeth are lower than the base of the tires. Once the work machine alignment assistance algorithm 30 is activated 30a, the initializing algorithm 31 will determine the initial position 23a₁ and 23b₁ of the laser vertical plane 19 within the horizontal laser sensing width 21 of the laser receiver group 20. The alignment of the backhoe loader 11 with the predetermined work machine path 18 is maintained by maintaining the position of the laser vertical plane 19 within the horizontal laser sensing width 21 at each of the plurality of work machine positions 35 along the predetermined work machine path 18. The initial positions 23a₁ and 23b₁ will be communicated to the work machine assistance algorithm 30 within the electronic control module 24. The initial, aligned position 35₁ of the backhoe loader 11 with the predetermined work machine path 18 is initialized by storing the sensed initial positions 23a₁ and 23b₁ of the laser vertical plane 19 within the horizontal laser sensing width 21.

Once the alignment of the backhoe loader 11 with the predetermined work machine path 18 is initialized, the operator will begin digging the trench. Eventually, the operator will move from the initial, aligned position 35₁ to a subsequent work machine position 35₂. The operator will move the backhoe loader 11 by the efficient method, known in the art as the “duck walk.” Because the “duck walk” can result in misalignment of the backhoe loader 11 with the predetermined work machine path 18, the work machine alignment assistance algorithm 30 will provide alignment correction information to the operator at the subsequent work machine position 35₂. Prior to the operator digging at the subsequent position 35₂, the laser receivers 23a and 23b will sense the subsequent positions 23a₂ and 23b₂ of the laser vertical plane 19 within the horizontal laser sensing width 21. In the illustrated version, the lasers 23a and 23b will sense the subsequent positions 23a₂ and 23b₂ when the electronic control module 24 determines that the backhoe 13 is in the digging position by sensing the location of the bucket of the backhoe 13 with respect to the work machine body 12. The comparing algorithm 32 will compare the initial position 23a₁ and 23b₁ of the laser vertical plane 19 with the subsequent position 23a₂ and 23b₂ of the laser vertical plane 19 within the horizontal laser sensing width 21.

The indicating algorithm 33 will then visually indicate alignment correction information to the operator of the backhoe loader 11. If both subsequent positions 23a₂ and 23b₂ are within a predetermined tolerance of the initial positions 23a₁ and 23b₁, the alignment correction information will indicate, through the visual display 29 of the alignment deviation indicator 26, that both the back 11b and the front 11a of the backhoe loader 11 are aligned with the predetermined work machine path 18. If either one or both of the subsequent positions 23a₂ and 23b₂ differ greater than the predetermined tolerance from the initial positions 23a₁ and 23b₁, the work machine alignment assistance algorithm 30 will determine how the subsequent positions 23a₂ and 23b₂ differ from the initial positions 23a₁ and 23b₁. In other words, the work machine alignment assistance algorithm 30 will determine which horizontal direction is the subsequent position 23b₁ or 23b₂ from the initial positions 23a₁ or 23a₂. The indicating algorithm 33 will indicate the alignment correction information, including whether the front 11a or back 11b or both of the backhoe loader 11 is misaligned and what direction the operator must move the backhoe loader to align the machine. Although the alignment correction information is displayed to the operator via the visual display 29, it should be appreciated that the alignment correction information could be displayed in various manners, including audibly. Moreover, the correction of the alignment deviation could be accomplished by automated means known in the art rather than the operator.

Once the operator corrects the alignment deviation based on the alignment correction information, the operator can continue digging along the predetermined work machine path 18. The process can be repeated for each subsequent positions 35_{3,4,5, . . .} along the path 18.

The present disclosure is advantageous because it provides a relatively inexpensive and simple method of maintaining alignment of the backhoe loader 11 with the predetermined path 18 for the trench. Thus, the backhoe loader 11 can dig a straight trench regardless of the length of the trench. The work machine alignment system 10 will indicate to the operator when the backhoe loader 11 has moved off of the predetermined path 18 of the trench and which direction the operator should move the back 11b and/or the front 11a of the backhoe loader 11 in order to re-align before digging. Because the operator can move the backhoe loader 11 along the predetermined path 18 of the trench in the most efficient manner known in the art, i.e., the “duck walk”, while also maintaining alignment with the trench, the end result will be an accurately and efficiently dug trench.

It should be understood that the description is intended for illustrative purposes only, and is not intended to limit the scope of the present invention in any way. Thus, those skilled in the art will appreciate that other aspects, objects, and advantages of the invention can be obtained from a study of the drawings, the disclosure and the appended claims.

What is claimed is:

1. A work machine comprising:
a work machine body;
a laser receiver group being operable to sense a laser vertical plane, and including more than one laser sensing point along a horizontal laser sensing width, and the laser receiver group including at least one laser receiver positioned at a fixed location on the work machine body; and
an electronic control module being in communication with the laser receiver group and including a work machine alignment assistance algorithm.

2. The work machine of claim 1 including an alignment deviation indicator being in communication with the electronic control module and being operable to provide alignment correction information to an operator via a visual display that is visible to an operator of the work machine.

3. The work machine of claim 1 wherein the horizontal laser sensing width includes a continuous laser sensing width.

4. The work machine of claim 1 including a digging implement moveably attached to the work machine body about a pivot; and
the at least one laser receiver including a first laser receiver attached to the work machine body adjacent to the pivot.

5. The work machine of claim 4 wherein the laser receiving group includes the first laser receiver and a second laser receiver; and
the first laser receiver includes a fore laser receiver, and the second laser receiver includes an aft laser receiver.

6. The work machine of claim 5 wherein the digging implement includes a backhoe;
the horizontal laser sensing width includes a continuous laser sensing width; and
an alignment deviation indicator being in communication with the electronic control module and being operable to provide alignment correction information to the operator via a visual display that is visible to an operator of the work machine.

7. A work machine alignment system comprising:
a work machine including a work machine body;
a laser generator operable to produce a laser vertical plane parallel to a predetermined work machine path;
a laser receiver group operable to sense a position of the laser vertical plane within a horizontal laser sensing width of the laser receiver group;
one of the laser generator and the laser receiver group being attached to the work machine body; and
an electronic control module being in communication with the laser receiver group and including a work machine alignment assistance algorithm.

8. The work machine alignment system of claim 7 wherein the work machine alignment assistance algorithm includes an initializing algorithm being operable to determine an initial position of the laser vertical plane within the horizontal laser sensing width when the work machine is aligned with the predetermined work machine path.

9. The work machine alignment system of claim 8 wherein the work machine alignment assistance algorithm includes a comparing algorithm being operable to compare a subsequent laser vertical plane position with the initial position of the laser vertical plane.

10. The work machine alignment system of claim 9 wherein the work machine assistance algorithm includes an indicating algorithm being operable to provide alignment correction information to an operator.

11. The work machine alignment system of claim 10 wherein the laser receiver group includes at least one laser receiver being attached to a fixed location on the work machine body.

12. The work machine alignment system of claim 11 wherein the horizontal laser sensing width includes a continuous laser sensing width.

13. The work machine alignment system of claim 12 including a digging implement moveably attached to the work machine body about a pivot; and
the at least one laser receiver being a first laser receiver attached to the work machine body adjacent to the pivot.

14. The work machine alignment system of claim 13 wherein the laser receiving group includes the first laser receiver and a second laser receiver; and
the first laser receiver includes a fore laser receiver, and a second laser receiver includes an aft laser receiver.

15. The work machine alignment system of claim 14 wherein the digging implement includes a backhoe.

16. A method of maintaining alignment of a work machine along a predetermined work machine path, comprising the steps of:
aligning at least one of an implement plane and a work machine axis of the work machine with the predetermined work machine path;
casting a laser vertical plane via a laser generator parallel to the predetermined work machine path;
sensing a position of the laser vertical plane within a horizontal laser sensing width of a laser receiver group attached at a fixed point to a work machine body of the work machine; and
maintaining alignment of the work machine with the predetermined work machine path, at least in part, by maintaining the position of the laser vertical plane within the horizontal laser sensing width at each of a plurality of work machine positions along the predetermined work machine path.

17. The method of claim 16 wherein the step of aligning includes the steps of aligning the work machine axis with the predetermined work machine path, and aligning the implement plane with the aligned work machine axis.

18. The method of claim 16 wherein the step of maintaining includes a step of initializing an aligned position of the work machine with the predetermined work machine path, at least in part, by storing the sensed position of the laser vertical plane within the horizontal laser sensing width.

19. The method of claim 16 wherein the step of maintaining includes a step of comparing at least one subsequent position of the laser vertical plane with a previously sensed position of the laser vertical plane within the horizontal laser sensing width.

20. The method of claim 16 wherein the step of maintaining includes a step of visually indicating alignment correction information to an operator of the work machine.
